(19) United States
(12) Patent Application Publication
(10) Pub. No.: US 2009/0314830 A1
(43) Pub. Date: Dec. 24, 2009

(54) DATA CARRIER AND DATA CARRIER SYSTEM

(75) Inventors: Kikuzo Sawada, Tokyo (JP); Yoshikazu Sugawara, Tokyo (JP); Takashi Kubo, Tokyo (JP)

Correspondence Address: ARENT FOX LLP, 1050 CONNECTICUT AVENUE, N.W., SUITE 400, WASHINGTON, DC, 20036, US

(73) Assignee: YOSHIKAWA RF SYSTEMS Co., Ltd., Fukuoka (JP)

(21) Appl. No.: 12/439,111

(22) PCT Filed: Aug. 30, 2007
(86) PCT No.: PCT/JP2007/066897

§ 371 Date: Feb. 26, 2009

(30) Foreign Application Priority Data
Aug. 31, 2006 (JP) 2006-234966

(51) Int. Cl. G06K 17/00; G06K 19/07; G06F 3/08

(52) U.S. Cl. 235/375

(57) ABSTRACT

Both of a proximity communication command in order to perform proximity communication with a reader/writer device and a vicinity communication command in order to perform vicinity communication with the reader/writer device are held in a command holding unit, and in the case when being inquired from the reader/writer device by using the proximity communication command, a response signal is generated by using the proximity communication command, and in the case when being inquired from the reader/writer device by using the vicinity communication command, the response signal is generated by using the vicinity communication command, resulting that both of the proximity communication and the vicinity communication can be performed depending on a usage mode.

### TECHNICAL FIELD

The present invention relates to a data carrier and a data carrier system, in particular, to preferable technique used for performing both proximity communication and vicinity communication.

### BACKGROUND ART

Conventionally, a data carrier system constituted by a data carrier and a reader/writer device to perform contactless data transmission and reception between the data carrier and the reader/writer device is practically applied in various fields. In such a data carrier system, an antenna installed in the data carrier receives an alternating magnetic field of a carrier frequency supplied from the reader/writer device via an antenna circuit to obtain operating power.

Further, it is constituted so that the reader/writer device modulates the magnetic field that it supplies and transmits an inquiry signal including a command and data, and the data carrier demodulates the inquiry signal to receive the command and the data transmitted from the reader/writer device (for example, see Patent Document 1).

By contrast, in the case when the data carrier transmits data to the reader/writer device, an on/off operation of a well-known load switch is performed for a load connected to an antenna circuit installed in the data carrier, in accordance with the contents of a response signal to be sent, and thereby, the response is sent. In such a way, it is constituted so that double sideband subcarriers are used as a frequency for responding from the data carrier, with respect to the carrier frequency of the alternating magnetic field supplied from the antenna circuit of the reader/writer device.

The data carrier is constituted to be provided with a storage section to store information and an antenna to transmit/receive information in a contactless manner in order to transmit and receive information in a contactless manner to/from the reader/writer device in use of electromagnetic fields or radio waves, and such a data carrier is utilized in various fields, being referred to as various names such as an RFID, an IC tag, an ID tag, an RF tag, a wireless tag, an electronic tag, a transponder, and the like.

The data carrier system is utilized in the various fields as described above, however, in the case when a contactless-type data carrier is a battery-less-type data carrier, power that is used by the data carrier is obtained from the alternating magnetic field supplied from the reader/writer device.

That is, the contactless-type data carrier includes an antenna for transmission/reception to receive the alternating magnetic field transmitted from a parent device called the reader/writer device via the antenna for transmission/reception, and rectifies current flowing depending on the size of the alternating magnetic field to obtain the rectified current as the operating power.

As application examples of the above-described data carrier system, a data carrier is disposed to, for example, vending machines, game machines, electricity meters, gas meters, water meters, home electronics, office automation equipment, productive facilities, and the like, and information such as operation histories, sales records and used amount of these electronic devices is recorded in the storage section of the data carrier.

The data carrier is utilized in the various fields, therefore, a usage mode thereof varies accordingly, however, the battery-less-type data carrier is broadly divided into two types, a proximity-type and a vicinity-type depending on an intended use thereof. The proximity-type data carrier is used at a proximity distance of about 1 cm to 10 cm. Also, the vicinity-type data carrier is used at a vicinity distance of about 10 cm to 70 cm.

As described above, since the intended purposes of the proximity-type data carrier and the vicinity-type data carrier are different, different commands are used for the proximity-type data carrier and the vicinity-type data carrier. That is, a command called a PICC command is used in the proximity-type data carrier. Also, a command called a VICC command is used in the vicinity-type data carrier.

Accordingly, a conventional data carrier is constituted to operate by either one of the PICC command and the VICC command. Therefore, it is necessary to constitute a data carrier to operate by an optimum command suitable for an operation environment of the data carrier. Thus, the data carrier is constituted to operate by the PICC command in the case when being used at the proximity distance of about 1 cm to 10 cm, and the data carrier is constituted to operate by the VICC command in the case when being used at the vicinity distance of about 10 cm to 70 cm.

Patent Document 1: Japanese Patent Application Laid-Open No. 2002-366907

### SUMMARY OF THE INVENTION

In the case when a data carrier is attached to an article, there is selected a data carrier of a type suitable for a state where the article is used. However, the article to which the data carrier is attached travels through various processes from the time when the article is manufactured in a factory to the time when the article is disposed. Then, when the article travels, a distribution management is performed in use of the data carrier.

Therefore, in the case when a proximity-type data carrier is attached to the article considering a state of use of the article, it does not respond to a VICC command of a vicinity-type data carrier, with the result that there is a problem that data carrier communication between the proximity-type data carrier and a vicinity-type reader/writer device is not possible even though the proximity-type data carrier is called from the vicinity-type reader/writer device used for the distribution management by the VICC command in a state where the article to which the proximity-type data carrier is attached is distributed in a cardboard box.

In order to eliminate such a problem, a vicinity-type data carrier is attached to the article to make the distribution management of the article possible in the case when the proximity-type data carrier is attached to the article considering the main state of use.

As described above, in the case when the data carrier suitable for the main state of use is the proximity-type, the time when the vicinity-type data carrier is used is an extremely limited period such as in shipment from the factory, in the distribution management, or the time when a lifetime of the article ends and the article is disposed. Attaching the vicinity-type data carrier to the article extra in order to use in such a limited period results in a significant disadvantage in terms of a cost.

The present invention is made in view of the above-described problems and has an object to provide a data carrier capable of communicating with both of a reader/writer device using a proximity-type command and a reader/writer device using a vicinity-type command.

The data carrier of the present invention is a data carrier constituting a data carrier system with a reader/writer device, the data carrier including a command holding unit holding both of a proximity communication command in order to perform proximity communication with the reader/writer device and a vicinity communication command in order to perform vicinity communication with the reader/writer device.

Further, another characteristic of the data carrier of the present invention is that a data carrier constituting a data carrier system with a reader/writer device includes: a command holding unit holding both of a proximity communication command in order to perform proximity communication with the reader/writer device and a vicinity communication command in order to perform vicinity communication with the reader/writer device; a signal reception unit receiving an inquiry signal transmitted from the reader/writer device; a command analysis unit analyzing whether a type of the inquiry signal received by the signal reception unit is the proximity communication command or the vicinity communication command; a command reading unit reading either the proximity communication command or the vicinity communication command from the command holding unit as a command to communicate with the reader/writer device based on an analysis result of the command analysis unit; and a command transmission unit transmitting the inquiry signal in which the communication command read by the command reading unit is used to the reader/writer device.

Further, another characteristic of the data carrier of the present invention is that the command analysis unit analyzes whether the type of the inquiry signal is the proximity communication command or the vicinity communication command based on a subcarrier frequency, a communication speed, or load modulation intensity of the signal received by the signal reception unit.

The data carrier system of the present invention is a data carrier system constituted by a data carrier and a reader/writer device communicating with the data carrier, and in which the data carrier includes a command holding unit holding both of a proximity communication command in order to perform proximity communication with the reader/writer device and a vicinity communication command in order to perform vicinity communication with the reader/writer device.

Further, another characteristic of the data carrier system of the present invention is that a data carrier system is constituted by a data carrier and a reader/writer device communicating with the data carrier, and in which the data carrier includes: a command holding unit holding both of a proximity communication command in order to perform proximity communication with the reader/writer device and a vicinity communication command in order to perform vicinity communication with the reader/writer device; a signal reception unit receiving an inquiry signal transmitted from the reader/writer device; a command analysis unit analyzing whether a type of the inquiry signal received by the signal reception unit is the proximity communication command or the vicinity communication command; a command reading unit reading either the proximity communication command or the vicinity communication command from the command holding unit as a command to communicate with the reader/writer device based on an analysis result of the command analysis unit; and a command transmission unit transmitting the inquiry signal in which the communication command read by the command reading unit is used to the reader/writer device.

Further, another characteristic of the data carrier system of the present invention is that the command analysis unit analyzes whether the type of the inquiry signal is the proximity communication command or the vicinity communication command based on a subcarrier frequency, a communication speed, or load modulation intensity of the signal received by the signal reception unit.

### BRIEF DESCRIPTION OF THE DRAWINGS

FIG. 1 is a block diagram showing a constitution example of a data carrier according to an embodiment of the present invention;

FIG. 2 is a diagram explaining a schematic constitution of a data carrier system constituted by a reader/writer device and the data carrier according to the embodiment of the present invention;

FIG. 3 is a view showing a configuration example of a command control circuit of the embodiment and explaining an example of reading either a PICC command or a VICC command;

FIG. 4 is a waveform diagram explaining one example of a data carrier signal;

FIG. 5A is a view showing a state in which the data carrier is attached to a device component;

FIG. 5B is a view showing a state in which the data carriers attached to the device components are packed in a cardboard box and shipped from a factory to be utilized in a distribution management; and

FIG. 5C is a view showing a state in which the device component is installed in a device body for use.

### DETAILED DESCRIPTION OF THE PREFERRED EMBODIMENTS

Hereinafter, an embodiment of a data carrier system of the present invention will be described with reference to the drawings.

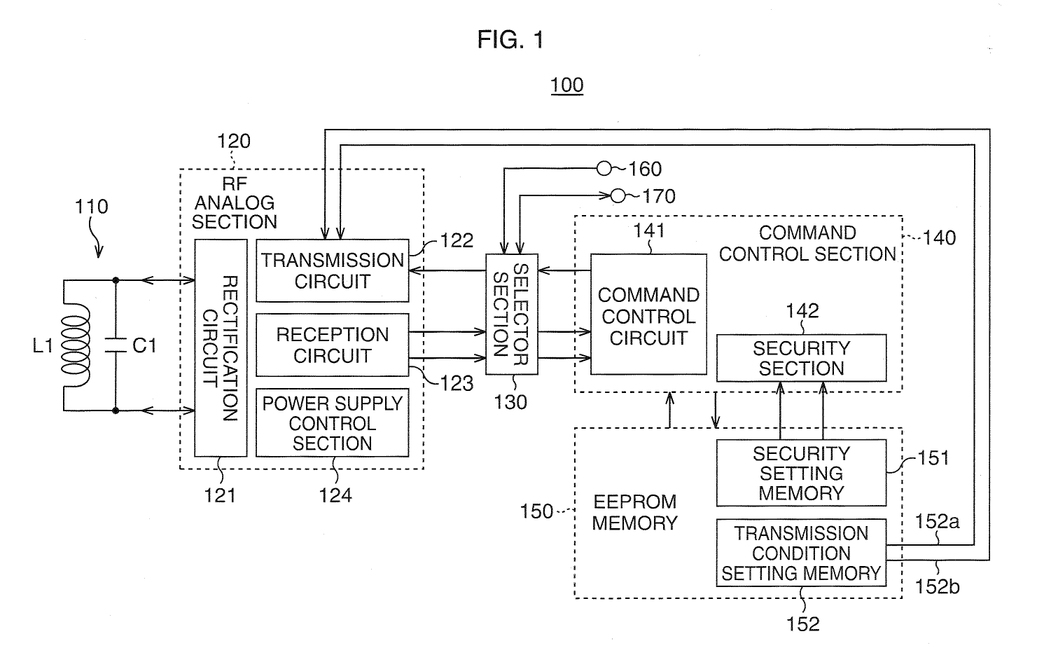

As shown in FIG. 1, a data carrier 100 in this embodiment is constituted by an antenna circuit 110, an RF analog section 120, a selector section 130, a command control section 140, a storage section 150, a first contact terminal 160, a second contact terminal 170, and so on.

The antenna circuit 110 is constituted by a parallel resonant circuit made by a coil L1 and a capacitor C1.

The RF analog section 120 is constituted by a rectification circuit 121, a transmission circuit 122, a reception circuit 123, a power supply control section 124, and so on.

The command control section 140 includes a command control circuit 141 and a security section 142. The storage section 150 includes a security setting memory 151 and a transmission condition setting memory 152.

In this embodiment, a PICC command 152a and a VICC command 152b are stored in the transmission condition setting memory 152. Either the PICC command 152a or the VICC command 152b is read from the transmission condition setting memory 152 depending on control by the command control section 140 and is provided to the transmission circuit 122.

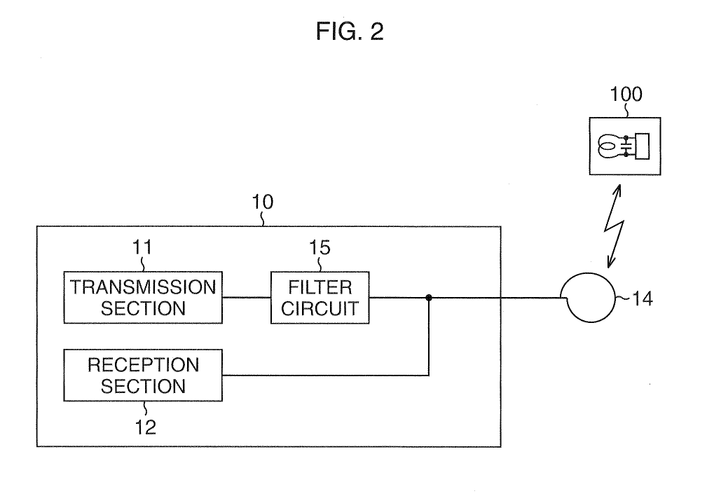

As shown in FIG. 2, a reader/writer device 10 that communicates with the above-described data carrier 100 is constituted by a transmission section 11, a reception section 12, an antenna circuit 14, a filter circuit 15, and so on. And then, commands and data are transmitted to the data carrier 100 from the antenna circuit 14, and transmission/reception is performed between the reader/writer device 10 and the data carrier 100.

The transmission section 11 is to generate a transmission signal made by the command and the data to be transmitted to the data carrier 100, and is constituted by a computer system such as a CPU, an RAM, and an ROM which are not shown, and modulates a predetermined carrier frequency f₀ (13.56 MHz) to generate the transmission signal. The reception section 12 decodes a subcarrier frequency transmitted from the data carrier 100 to demodulate the data.

The antenna circuit 14 transmits the transmission signal output from the transmission section 11 to the data carrier 100 and receives a response signal transmitted from the data carrier 100. The above-descried constitution is a general constitution of the data carrier 100 applied in the data carrier system, however, the data carrier 100 in this embodiment has a characteristic that is applicable to both proximity-type data communication and vicinity-type data communication.

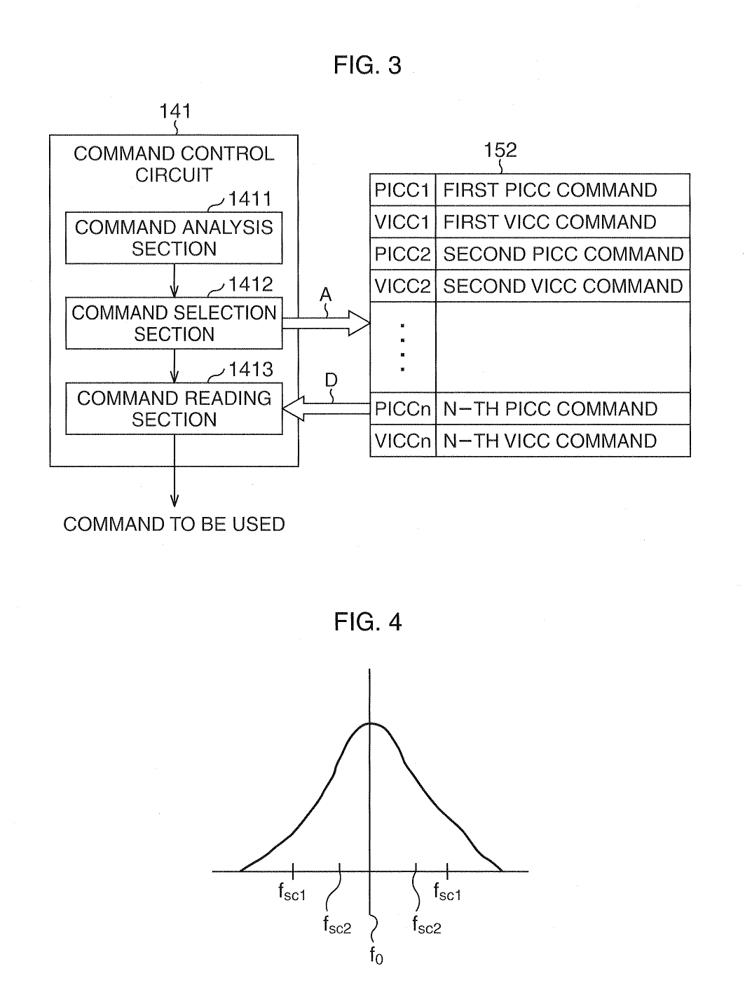

One example of a constitution to read either the PICC command 152a or the VICC command 152b is shown in FIG. 3.

As shown in FIG. 3, the command control circuit 141 in this embodiment includes a command analysis section 1411, a command selection section 1412, and a command reading section 1413.

The command analysis section 1411 is to determine whether an inquiry signal 41 transmitted from the reader/writer device 10 is a proximity communication command or a vicinity communication command, and outputs the determination result to the command selection section 1412.

The command selection section 1412 is to select a command of a response signal 42 to be transmitted to the reader/writer device 10 depending on an analysis result of a command transmitted from the command analysis section 1411, and specifies an address A where the command of the type to be selected is stored to the transmission condition setting memory 152.

The command reading section 1413 reads the command of the type selected by the command selection section 1412, namely data D of the proximity communication command or the vicinity communication command from the transmission condition setting memory 152 as a command used to communicate with the reader/writer device 10, and outputs the data D to the transmission circuit 122 as shown in FIG. 1.

Based on such a constitution, the data carrier 100 in this embodiment is constituted so that, as shown in FIG. 4, double sideband subcarriers of a first subcarrier frequency fsc1 and a second subcarrier frequency fsc2 are used with respect to a carrier frequency of an alternating magnetic field supplied from the antenna circuit in the reader/writer device as a frequency for the response signal 42 in response to the inquiry signal 41 transmitted from the reader/writer device 10.

As shown in the explanatory diagram of the carrier frequency in FIG. 4, in this embodiment, the first subcarrier frequency fsc1 (847.5 kHz) is used as the primary proximity communication command (PICC command) and the second subcarrier frequency fsc2 (437.75 kHz) is used as the vicinity communication command (VICC command). In its reception characteristic, the center frequency is 13.56 MHz, the communication speed is 105.94 kbps, and the modulation method is ASK (NRZ). Also, in its transmission characteristic, the center frequency is 13.56 MHz, the communication speed is 105.94 kbps, and the modulation method is BPSK (NRZ).

Further, in this embodiment, it is constituted so that subcarrier intensity can be changed by increasing or reducing a load. It is constituted so that the degree of the change can be changed in eight levels in each of the PICC command and the VICC command. Further, the relative ratio of the PICC command to the VICC command is set to be about 1:3.

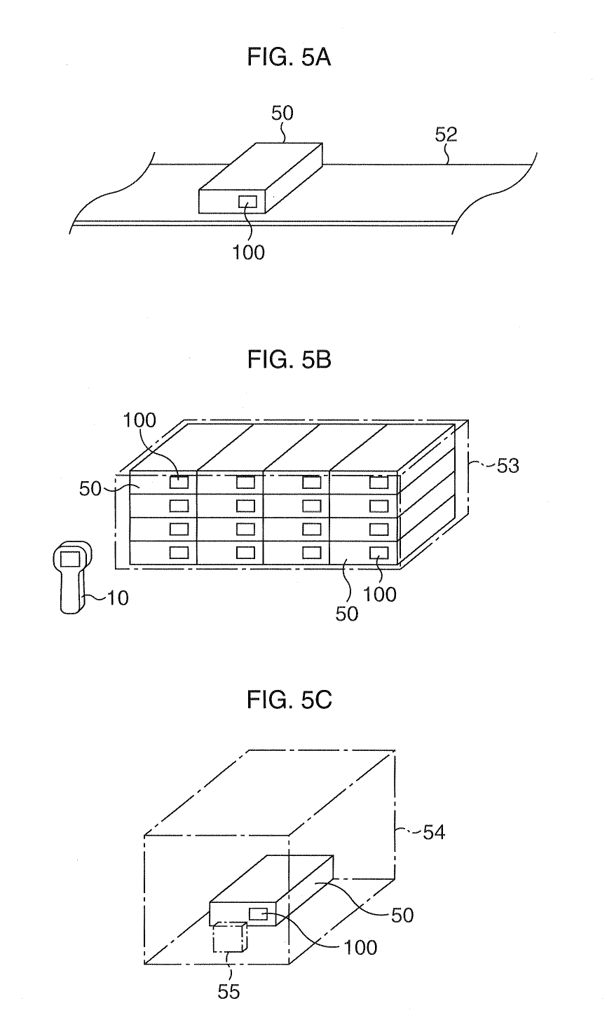

Next, a usage example of the data carrier 100 in this embodiment constituted as described above will be described with reference to FIGS. 5A to 5C.

FIG. 5A shows a state where the data carrier 100 is attached to a device component 50, and for example, the device component 50 is mounted on a conveyor belt 52 and manufacturing information such as “serial number”, “date of manufacture”, “names of materials”, and “shipping date” is written in the data carrier 100 in each process of a manufacturing factory of the device component 50. The proximity communication command is used in this state.

FIG. 5B shows a state where the data carriers 100 attached to the device components 50 are packed in a cardboard box 53 and shipped from the factory to be used in a distribution management. In this state, the reader/writer device 10 transmits the inquiry signal 41 from outside the cardboard box 53, so the distance from the data carrier 100 to the reader/writer device 10 is far away. Further, in this state, the inquiry signal 41 is transmitted from the reader/writer device 10 by the vicinity communication command (VICC command).

Accordingly, as the response signal 42 to be transmitted from the data carrier 100, it is necessary to use the vicinity communication command (VICC command). In the data carrier 100 in this embodiment, as described above, both of the proximity communication command (PICC command) and the vicinity communication command (VICC command) can be used, therefore, the data carrier 100 is suitably used even when the device component 50 is packed in the cardboard box 53.

FIG. 5C shows a state where the device component 50 is installed in a device body 54. In this state, since the distance from the data carrier 100 to a reader/writer device 55 provided to the device body 54 results in a close range, communication between the device component 50 and the reader/writer device 55 is performed by the proximity communication command (PICC command).

As described above, the data carrier 100 in this embodiment can be operated by not only the proximity communication command (PICC command) but also the vicinity communication command (VICC command), and thereby, all of recording the manufacturing information in the manufacturing factory, recording related to the distribution management, and recording related to a management of a state of use can be well performed with the single data carrier.

Therefore, it is not necessary to attach both of the data carrier of the proximity communication command (PICC command) and the data carrier of the vicinity communication command (VICC command) to a component in order to perform a manufacturing process management, a distribution process management, and a usage process management consistently as has been done conventionally, and a cost necessary for an information management can be reduced considerably.

### INDUSTRIAL APPLICABILITY

According to the present invention, both of a proximity communication command in order to perform proximity communication with a reader/writer device and a vicinity communication command in order to perform vicinity communication with the reader/writer device are held in a command holding unit, with the result that it is possible to provide a data carrier capable of communicating with both of a reader/writer device in which a proximity-type command is used and a reader/writer device in which a vicinity-type command is used.

What is claimed is:

1. A data carrier constituting a data carrier system with a reader/writer device, the data carrier comprising:
a command holding unit holding both of a proximity communication command in order to perform proximity communication with the reader/writer device and a vicinity communication command in order to perform vicinity communication with the reader/writer device.

2. A data carrier constituting a data carrier system with a reader/writer device, the data carrier comprising:
a command holding unit holding both of a proximity communication command in order to perform proximity communication with the reader/writer device and a vicinity communication command in order to perform vicinity communication with the reader/writer device;
a signal reception unit receiving an inquiry signal transmitted from the reader/writer device;
a command analysis unit analyzing whether a type of the inquiry signal received by the signal reception unit is the proximity communication command or the vicinity communication command;
a command reading unit reading either the proximity communication command or the vicinity communication command from the command holding unit as a command to communicate with the reader/writer device based on an analysis result of the command analysis unit; and
a command transmission unit transmitting the inquiry signal in which the communication command read by the command reading unit is used to the reader/writer device.

3. The data carrier according to claim 2, wherein
the command analysis unit analyzes whether the type of the inquiry signal is the proximity communication command or the vicinity communication command based on a subcarrier frequency, a communication speed, or load modulation intensity of the signal received by the signal reception unit.

4. A data carrier system comprising:
a data carrier; and
a reader/writer device communicating with the data carrier, and wherein
the data carrier comprises:
a command holding unit holding both of a proximity communication command in order to perform proximity communication with the reader/writer device and a vicinity communication command in order to perform vicinity communication with the reader/writer device.

5. A data carrier system comprising:
a data carrier; and
a reader/writer device communicating with the data carrier, and wherein
the data carrier comprises:
a command holding unit holding both of a proximity communication command in order to perform proximity communication with the reader/writer device and a vicinity communication command in order to perform vicinity communication with the reader/writer device;
a signal reception unit receiving an inquiry signal transmitted from the reader/writer device;
a command analysis unit analyzing whether a type of the inquiry signal received by the signal reception unit is the proximity communication command or the vicinity communication command;
a command reading unit reading either the proximity communication command or the vicinity communication command from the command holding unit as a command to communicate with the reader/writer device based on an analysis result of the command analysis unit; and
a command transmission unit transmitting the inquiry signal in which the communication command read by the command reading unit is used to the reader/writer device.

6. The data carrier system according to claim 5, wherein
the command analysis unit analyzes whether the type of the inquiry signal is the proximity communication command or the vicinity communication command based on a subcarrier frequency, a communication speed, or load modulation intensity of the signal received by the signal reception unit.
